(19) United States
(12) Patent Application Publication
(10) Pub. No.: US 2022/0017095 A1
(43) Pub. Date: Jan. 20, 2022

(54) VEHICLE-BASED DATA ACQUISITION

(71) Applicant: Ford Global Technologies, LLC, Dearborn, MI (US)

(72) Inventors: Helen Kourous-Harrigan, Monroe, MI (US); John Anthony Lockwood, Howell, MI (US)

(73) Assignee: Ford Global Technologies, LLC, Dearborn, MI (US)

(21) Appl. No.: 16/928,063

(22) Filed: Jul. 14, 2020

(51) Int. Cl. B60W 40/02; G07C 5/08; G07C 5/00; B60W 60/00; G01C 21/28; G06T 17/00; G06T 7/70

(52) U.S. Cl. CPC B60W 40/02; G07C 5/085; G07C 5/008; B60W 60/0025; G01C 21/28; G06T 17/00; G06T 2207/30252; B60W 2420/42; B60W 2420/52; B60W 2552/00; B60W 2555/20; B60W 2554/80; G06T 7/70

(57) ABSTRACT

A computer can execute instructions to collect vehicle sensor data from sensors on a vehicle. Based on a determination that the vehicle is within a threshold distance of a road infrastructure geofence indicating a presence of a target road infrastructure element, the instructions further include to identify selected data from the vehicle sensor data; and transmit the selected data to a remote server.

### BACKGROUND

Road infrastructure elements such as roads, bridges, and tunnels, can deteriorate over time due to use and exposure to the environmental elements such as sunlight, extreme temperatures, temperature variations, precipitation, wind, etc. Obtaining data about road infrastructure elements can be difficult, especially where indications of infrastructure element conditions may be located in regions, e.g., under a bridge, in a roof of a tunnel, that are difficult to detect.

### BRIEF DESCRIPTION OF THE DRAWINGS

FIG. 1 is a diagram of an example system for acquiring images and 3D models of road infrastructures.

FIG. 2A is a top view of an example vehicle illustrating example fields-of-view of selected vehicle sensors.

FIG. 2B is a side view of the example vehicle of FIG. 2A, illustrating example fields-of-view of selected vehicle sensors.

FIG. 3 illustrates an example of a vehicle acquiring data of a road infrastructure element.

FIG. 4 is a diagram of an example process for collecting data from a road infrastructure element and transmitting the data.

FIG. 5 is a diagram of an example process for identifying selected data.

FIG. 6 is a diagram of an example process for uploading data.

FIG. 7 is a diagram of an example process for conditioning data for use evaluating the condition of road infrastructure elements.

### DETAILED DESCRIPTION

A system comprises a computer including a processor and a memory, the memory including instructions executable by the processor, including instructions to collect vehicle sensor data from sensors on a vehicle. The instructions further include, based on a determination that the vehicle is within a threshold distance of a road infrastructure geofence indicating a presence of a target road infrastructure element, to identify selected data from the vehicle sensor data; and transmit the selected data to a remote server.

Further, in the system, identifying the selected data may include identifying one or more types of selected data.

Further, in the system, the one or more types of selected data may be selected from a set including camera data and LiDAR data.

Further, in the system, identifying the one or more types of selected data may be based on a received mission instruction.

Further, in the system, the received mission instruction may specify the one or more types of data to be selected and the instructions may include to identify the selected data based on the specification of the one or more types of data in the mission instruction.

Further, in the system, the received mission instruction may specify a condition or a type of deterioration of the target road infrastructure element to be evaluated, and the instructions may include to determine the one or more types of data based the specified condition or type of deterioration to be evaluated.

Further, in the system, identifying the selected data may be based on one or more target road infrastructure element parameters.

Further, in the system, the one or more infrastructure element parameters may include at least one of: a type of the target road infrastructure element; a location of the target road infrastructure element; a physical characteristic of the target road infrastructure element; or a geolocation of a target section of the target road infrastructure element.

Further, in the system, identifying the selected data may include at least one of: identifying a sensor from which the selected data is generated; or identifying a timing when the selected data was generated.

Further, in the system, identifying the selected data may be based on one or more vehicle parameters.

Further, in the system, the one or more vehicle parameters may include at least one of: a geolocation of the vehicle; or a field-of-view of a sensor on the vehicle.

Further, in the system, the instructions may include to store the selected data on a memory store on the vehicle; and transmit the selected data to the remote server when the vehicle is within range of a data collection terminal.

Further, in the system, the instructions may include to store the selected data on a memory store on the vehicle prior to transmitting the selected data; and store a geolocation of the vehicle at a time the vehicle sensor data was selected together with the selected data.

Further, in the system, the geolocation of the vehicle at the time the vehicle sensor data was collected may be determined based on at least one of data from a LiDAR sensor included on the vehicle or data from a camera sensor included on the vehicle.

Further, in the system, the instructions may include to identify the selected data based on a field of view of a sensor at a time of collecting the vehicle sensor data.

Further, in the system, the instructions may include to determine a localized position of the vehicle based on at least one of LiDAR data or camera data; and determine the field of view of the sensor based on the localized position of the vehicle.

Further, in the system, the instructions may include to transmit weather data together with the selected data, the weather data indicating weather conditions at a time of collecting the vehicle data.

Further, the system may include the remote server, the remote server including a second processor and a second memory, the second memory including second instructions executable by the processor, including second instructions to receive the selected data transmitted by the processor; extract second data about a target road infrastructure element from the selected data; and transmit the second data to a second server.

Further, in the system, extracting the second data may include second instructions to remove personally identifying information from the second data prior to transmitting the second data to the second server.

Further, in the system, extracting the second data may include second instructions to generate an image and/or 3D model from the selected data; divide the generated image and/or 3D model into segments; determine which segments include data about the target road infrastructure element; and include in the second data, the segments including the data about the target road infrastructure element.

During operation, vehicles can collect data about road infrastructure elements, such as roads, bridges, tunnels, etc. For example, vehicles use LiDAR sensors to collect point cloud data, and cameras to collect visual data, that can be used to operate the vehicle. When the vehicles are within range of a target road infrastructure element, the vehicle data collected by the vehicle can include point cloud data and visual data of target road infrastructure elements, which can be used to evaluate a condition of the target road infrastructure element. The vehicle can be instructed to store selected vehicle data when the vehicle is within range of the target road infrastructure element. When the vehicle, typically after collecting and storing the data, is within range of a data collection terminal, the vehicle computer can upload this data to a server for further processing. The data can be conditioned to remove extraneous data and any personally identifiable data. Thereafter, the data about the target road infrastructure element can be used to evaluate the condition of the target road infrastructure element.

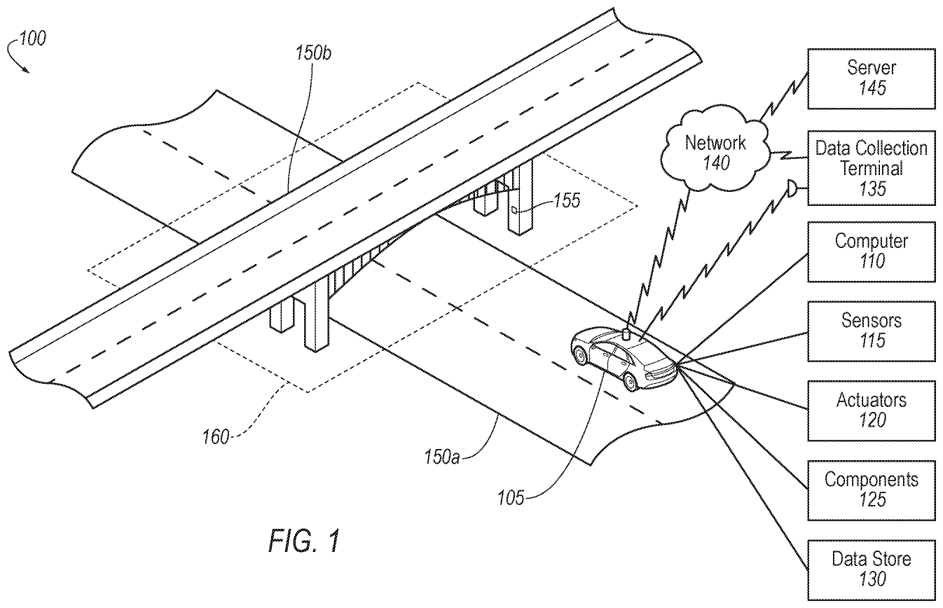

FIG. 1 illustrates an example system 100 for collecting vehicle data by a vehicle 105, selecting data from the vehicle data that is about a target road infrastructure element 150, and storing and/or transmitting the data to a server for further processing. Data about a target road infrastructure element 150 herein means data including physical characteristics of the target road infrastructure element 150. Physical characteristics of the target road infrastructure element 150 are physical qualities or quantities that can be measured and/or discerned and can include: features such as the shape; size; color; surface characteristics such as cracks, spalling, corrosion; positions of elements of the target road infrastructure element (for example to determine displacement of the element relative to other elements or relative to a previous position); vibrations; and other characteristics that may be used to evaluate a condition of the target road infrastructure element 150.

A computer 110 in the vehicle 105 receives a request (digital instruction) to select and store data from the vehicle data for the target road infrastructure element 150. The request may include a map of the environment in which the vehicle 105 will execute a mission, a geofence 160, and additional data specifying or describing the target road infrastructure element 150 and the vehicle data to be selected, as described below in reference to the process 400. The geofence 160 is a polygon that identifies an area surrounding the target road infrastructure element 150. When the vehicle 105 is within a threshold range of the geofence 160, the computer 110 begins to select data from the vehicle data and store the selected data.

The computer 110 is generally programmed for communications on a vehicle 105 network, e.g., which may include one or more conventional vehicle 105 communications wired or optical buses such as a CAN buses, LIN buses, Ethernet buses, Flexray buses, MOST buses, single-wire custom buses, double-wire custom buses, etc., and may further include one or more wireless technologies, e.g., WIFI, Bluetooth®, Bluetooth® Low Energy (BLE), Near Field Communications (NFC), Dedicated Short-Range Communications (DSRC), Cellular Vehicle-to-Everything (C-V2X), etc. Via the vehicle network, the computer 110 may transmit messages to various devices in the vehicle 105 and/or receive messages from the various devices, e.g., controllers, sensors 115, actuators 120, components 125, the data store 130, etc. Alternatively or additionally, in cases where the computer 110 actually comprises multiple devices, the vehicle network may be used for communications between devices represented as the computer 110 in this disclosure. For example, the computer 110 can be a generic computer with a processor and memory as described above and/or may include a dedicated electronic circuit including: one or more electronic components such as resistors, capacitors, inductors, transistors, etc.; application specific integrated circuits (ASICs); field-programmable gate arrays (FPGAs); custom integrated circuits, etc. Each of the ASICs, FPGAs, and custom integrated circuits may be configured (i.e., include a plurality of internal electrically coupled electronic components), and may further include embedded processors programmed via instructions stored in a memory, to perform vehicle operations such as receiving and processing user input, receiving and processing sensor data, transmitting sensor data, planning vehicle operations, and controlling vehicle actuators and vehicle components to operate the vehicle 105. In some cases, the ASICs, FPGAs and custom integrated circuits may be programmed in part or in whole by an automated design system, wherein a desired operation is input as a functional description, and the automated design system generates the components and/or the interconnectivity of the components to achieve the desired function. Very High-Speed Integrated Circuit Hardware Description Language (VHDL) is an example programming language for supplying a functional description of the ASIC, FPGA or customer integrated circuit to an automated design system.

In addition, the computer 110 may be programmed for communicating with the network 140, which, as described below, may include various wired and/or wireless networking technologies, e.g., cellular, Bluetooth®, Bluetooth® Low Energy (BLE), Dedicated Short-Range Communications (DSRC), Cellular Vehicle-to-Everything (C-V2X), wired and/or wireless packet networks, etc.

Sensors 115 can include a variety of devices. For example, various controllers in a vehicle 105 may operate as sensors 115 to provide vehicle data via the vehicle 105 network, e.g., data relating to vehicle speed, acceleration, location, subsystem and/or component status, etc. The sensors 115 can, without limitation, also include short range radar, long range radar, LIDAR, cameras, and/or ultrasonic transducers. The sensors 115 can also include a navigation system that uses the Global Positioning System (GPS), and that provides a location of the vehicle 105. The location of the vehicle 105 is typically provided in a conventional form, e.g., geo-coordinates such as latitude and longitude coordinates.

In addition to the examples of vehicle data provided above, vehicle data may include environmental data, i.e., data about the environment outside the vehicle 105 in which the vehicle 105 is operating. Non-limiting examples of environmental data include: weather conditions; light conditions; and two-dimensional images and three-dimensional models of stationary objects such as trees, buildings signs, bridges, tunnels, and roads. Environmental data further includes data about animate objects such as other vehicles, people, animals, etc. The vehicle data may further include data computed from the received vehicle data. In general, vehicle data may include any data that may be gathered by the sensors 115 and/or computed from such data.

Actuators 120 are electronic and/or electromechanical devices implemented as integrated circuits, chips, or other electronic and/or mechanical devices that can actuate various vehicle subsystems in accordance with appropriate control signals as is known. The actuators 120 may be used to control vehicle components 125, including braking, acceleration, and steering of the vehicle 105. The actuators 120 can further be used, for example, to actuate, direct, or position the sensors 115.

The vehicle 105 can include a plurality of vehicle components 125. In this context, each vehicle component 125 includes one or more hardware components adapted to perform a mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component, a park assist component, an adaptive cruise control component, an adaptive steering component, a movable seat, and the like. Components 125 can include computing devices, e.g., electronic control units (ECUs) or the like and/or computing devices such as described above with respect to the computer 110, and that likewise communicate via a vehicle 105 network.

The data store 130 can be of any type, e.g., hard disk drives, solid state drives, servers, or any volatile or non-volatile media. The data store 130 can store selected vehicle data including data from the sensors 115. For example, the data store 130 can store vehicle data that includes or may include data specifying and/or describing a target road infrastructure element 150 for which the computer 110 is instructed to collect data. The data store 130 can be a separate device from the computer 110, and the computer 110 can access (i.e., store data to and retrieve data from) the data store 130 via the vehicle network in the vehicle 105, e.g., over a CAN bus, a wireless network, etc. Alternatively or additionally, the data store 130 can be part of the computer 110, e.g., as a memory of the computer 110.

A vehicle 105 can operate in one of a fully autonomous mode, a semiautonomous mode, or a non-autonomous mode. A fully autonomous mode is defined as one in which each of vehicle 105 propulsion (typically via a powertrain including an electric motor and/or internal combustion engine), braking, and steering are controlled by the computer 110. A semi-autonomous mode is one in which at least one of vehicle 105 propulsion (typically via a powertrain including an electric motor and/or internal combustion engine), braking, and steering are controlled at least partly by the computer 110 as opposed to a human operator. In a non-autonomous mode, i.e., a manual mode, the vehicle 105 propulsion, braking, and steering are controlled by the human operator.

The system 100 may further include a data collection terminal 135. The data collection terminal 135 includes one or more mechanisms by which the vehicle computer 110 may wirelessly upload data to the server 145 and is typically located near a storage center or service center for the vehicle 105. As described below in reference to the process 600, the computer 110 in the vehicle 105 can upload the data via the data collection terminal 135 to the server 450 for further processing.

The data collection terminal 135 can be one or more of various wireless communication mechanisms, including any desired combination of wireless (e.g., cellular, wireless, satellite, microwave, and radio frequency) communication mechanisms. Exemplary communication mechanisms include wireless communication networks (e.g., using Bluetooth®, Bluetooth® Low Energy (BLE), IEEE 802.11, vehicle-to-vehicle (V2V) such as Dedicated Short-Range Communications (DSRC), etc.), Cellular Vehicle-to-Everything (C-V2X), local area networks (LAN) and/or wide area networks (WAN), including the Internet, providing data communication services.

The system 100 further includes a network 140 and a server 145. The network 140 communicatively couples the vehicle 105 to the server 145.

The network 140 represents one or more mechanisms by which a vehicle computer 110 may communicate with a remote server 145. Accordingly, the network 140 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short-Range Communications (DSRC), etc.), Dedicated Short-Range Communications (DSRC), Cellular Vehicle-to-Everything (C-V2X), local area networks (LAN) and/or wide area networks (WAN), including the Internet, providing data communication services.

The server 145 can be a conventional computing device, i.e., including one or more processors and one or more memories, programmed to provide operations such as disclosed herein. Further, the server 145 can be accessed via the network 140, e.g., the Internet or some other wide area network. The server 145 can provide data, such as map data, traffic data, weather data, etc. to the computer 110.

The server 145 can be additionally programmed to transmit mission instructions, identification of a target road infrastructure element 150 or target section of a road infrastructure element 150 for which the computer 110 should collect selected vehicle data, parameters defining a geofence 160 surrounding the target road infrastructure element and/or parameters defining selected vehicle data to be collected. To “collect selected vehicle data,” in this context means to identify selected vehicle data from the vehicle data that the computer 110 is receiving during vehicle operation and store the identified selected data in the data store 130 on the vehicle 105. Identifying selected vehicle data can be based on target road infrastructure element parameters, vehicle parameters, environment parameters and/or received instructions specifying the selected vehicle data, as described in additional detail below. Mission instructions, in this context is data including mission parameters that define a mission that the vehicle should execute. A mission parameter, as used herein, is a data value that at least partly defines a mission. The mission parameters may include an end destination, any intermediate destinations, respective times of arrival for the end and intermediate destinations, and vehicle maintenance operations (for example, fueling) to be performed during the mission, a route to be taken between destinations, as non-limiting examples.

The identification of the target road infrastructure element 150 or target section of the road infrastructure element 150 may include a location of the target road infrastructure element 150 or target section of the road infrastructure element 150. The location may be expressed in a conventional form, e.g., geocoordinates such as latitude and longitude. Alternatively or additionally, the location of the target road infrastructure element 150 or target section of the road infrastructure element 150 may be provided as two-dimensional or three-dimensional map data and may include a two-dimensional image and/or three-dimensional model of the target road infrastructure element 150 or target section of the road infrastructure element 150.

A road infrastructure element 150, as used herein, is a physical element of an environment that supports vehicles driving through the environment. Typically, the road infrastructure element is stationary and manmade, such as a road, a bridge, a tunnel, lane dividers, guard rails, posts, signage, etc. A road infrastructure element 150 can have moving parts, such as a drawbridge, and may also be a natural feature of the environment. For example, a road infrastructure element 150 may be a cliff that may require maintenance, for example, to reduce the likelihood of rockslides onto a neighboring road. A section of the road infrastructure element 150 is a part of the road infrastructure element 150 that is less than the whole infrastructure element 150, for example, an inside of a tunnel 150. A target road infrastructure element 150 herein means a road infrastructure element 150 or section of the infrastructure element 150 for which the computer 110 has received instructions to collect selected vehicle data.

Road infrastructure elements 150 can be subject to various types of wear and deterioration. Roads 150 may develop potholes, cracks, etc. Bridges and tunnels may be subject to spalling, cracking, bending, corrosion, loss of fasteners such as bolts, loss of protective surface coatings, etc.

A geofence 160, in this context means a virtual perimeter for a target road infrastructure element 150. The geofence 160 may be represented as a polygon defined by a set of latitude, longitude coordinate pairs surrounding the target road infrastructure element 150. The server 145 may define the geofence 160 to surround an area for which the computer 110 should collect image and/or 3D model data and that includes the target road infrastructure element 150. The computer 110 may dynamically generate the geofence 160 to for example, define a rectangular area around the target road infrastructure element 150, or the geofence 160 can be a predefined set of boundaries that are, e.g., included in the map data provided to the computer 110.

As discussed above, the vehicle 105 can have a plurality of sensors 115, including radar, cameras and LiDAR that provide vehicle data that the computer 110 can use to operate the vehicle.

Radar is a detection system that uses radio waves to determine the relative location, angle, and/or velocity of an object. The vehicle 105 may include one or more radar sensors 115 to detect objects in the environment of the vehicle 105.

The vehicle 105 includes one or more digital cameras 115. A digital camera 115 is an optical device that record images based on received light. The digital camera 115 includes a photosensitive surface (digital sensor), including an array of light receiving nodes, that receives the light and converts the light into images. Digital cameras 115 generate frames, wherein each frame is an image received by the digital camera 115 at an instant in time. Each frame of data can be digitally stored, together with metadata including a timestamp of when the image was received. Other metadata, such as a location of the vehicle 105 at the time when the image was received, the weather or light conditions when the images was received, may also be stored with the frame.

The vehicle 105 further includes one or more LiDAR sensors 115. LiDAR is a method for measuring distances by illuminating a target with laser light and measuring the reflection with a LiDAR sensor 115. Differences in laser return times and wavelengths can be used to generate digital 3-D representations of a target, referred to as point clouds. A point cloud is a collection of data points in space defined by a coordinate system and representing external surfaces of the detected target.

The LiDAR typically collects data in scans. For example, the LiDAR may execute 360° scans around the vehicle 105. Each scan may be completed in 100 mS, such that the LiDAR completes 10 full circle scans per second. During the scan, the LiDAR may complete tens of thousands of individual point measurements. The computer 110 may receive the scans and store the scans together with metadata including a timestamp, where the timestamp marks a point, for example the beginning, of each scan. Additionally or alternatively, each point from the scan can be stored with metadata, which may include an individual timestamp. LiDAR metadata may also include a location of the vehicle 105 when the data was collected, weather or light conditions when the data was received, or other measurements or conditions that may be useful in evaluating the data.

During operation of the vehicle 105 in an autonomous or semi-autonomous mode, the computer 110 may operate the vehicle 105 based on the vehicle data, including the radar, digital camera and LiDAR data. As described above, the computer 110 may receive mission instructions, which may include a map of the environment in which the vehicle 105 is operating, and one or more mission parameters. Based on the mission instructions, the computer 110 may determine a planned route for the vehicle 105. A planned route means a specification of the streets, lanes, roads, etc., along which the host vehicle plans to travel, including the order of traveling over the streets, lanes, roads, etc., and a direction of travel on each, for a trip, i.e., from an origin to a destination. During operation, the computer 110 operates the vehicle along a travel path. A used herein, a travel path is a line and/or curve (defined by points specified by coordinates such as geo-coordinates) steered by the host vehicle along the planned route.

For example, a planned path can be specified according to one or more path polynomials. A path polynomial is a polynomial function of degree three or less that describes the motion of a vehicle on a ground surface. Motion of a vehicle on a roadway is described by a multi-dimensional state vector that includes vehicle location, orientation speed and acceleration including positions in x, y, z, yaw, pitch, roll, yaw rate, pitch rate, roll rate, heading velocity and heading acceleration that can be determined by fitting a polynomial function to successive 2D locations included in vehicle motion vector with respect to the ground surface, for example.

Further for example, the path polynomial p(x) is a model that predicts the path as a line traced by a polynomial equation. The path polynomial p(x) predicts the path for a predetermined upcoming distance x, by determining a lateral coordinate p, e.g., measured in meters:

p(x)=a₀+a₁x+a₂x²+a₃x³ (1)

where a₀ an offset, i.e., a lateral distance between the path and a center line of the vehicle 101 at the upcoming distance x, a₁ is a heading angle of the path, a₂ is the curvature of the path, and a₃ is the curvature rate of the path.

As described above, the computer 110 may determine a location of the vehicle 105 based on vehicle data from a Global Positioning System (GPS). For operation in an autonomous mode, the computer 110 may further apply known localization techniques to determine a localized position of the vehicle 105 with a higher resolution than can be achieved with the GPS system. The localized position may include a multi-degree-of-freedom (MDF) pose of the vehicle 105. The MDF pose can comprise six (6) components, including an x-component (x), a y-component (y), a z-component (z), a pitch component (θ), a roll component (ϕ), and a yaw component (ψ), wherein the x-, y-, and z-components are translations according to a Cartesian coordinate system (comprising an X-axis, a Y-axis, and a Z-axis) and the roll, pitch, and yaw components are rotations about X-, Y-, and Z-axes, respectively. The vehicle localization techniques applied by the computer 110 may be based on vehicle data such as radar, camera and LiDAR data. For example, the computer 110 may develop a 3D point cloud of one or more stationary objects in the environment of the vehicle 105. The computer 110 may further correlate the 3D point cloud of the one or more objects with 3D map data of the objects. Based on the correlation, the computer 110 may determine with increased resolution provided via the GPS system, the location of the vehicle 105.

Referring again to FIG. 1, during execution of a mission, when the vehicle 105 comes within a threshold distance of a geofence 160 surrounding a target road infrastructure element 150, the computer 110 begins to store selected vehicle data to the memory store 130.

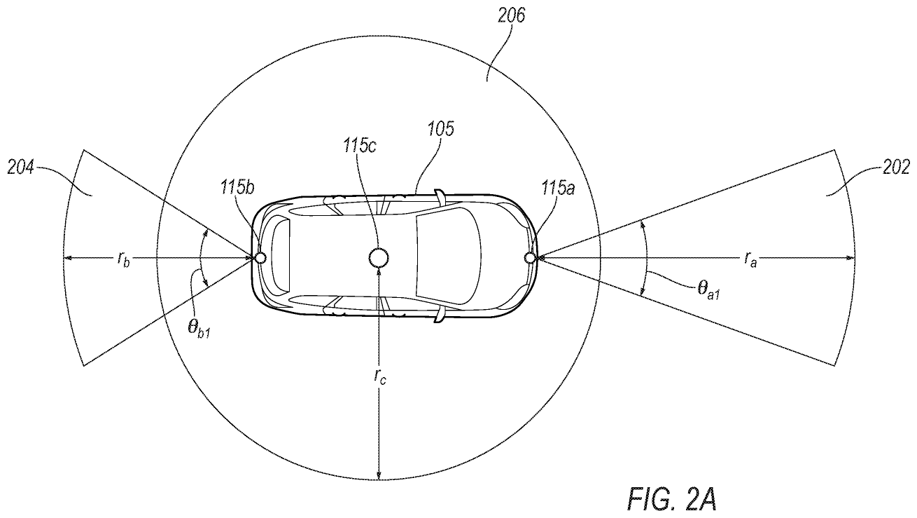

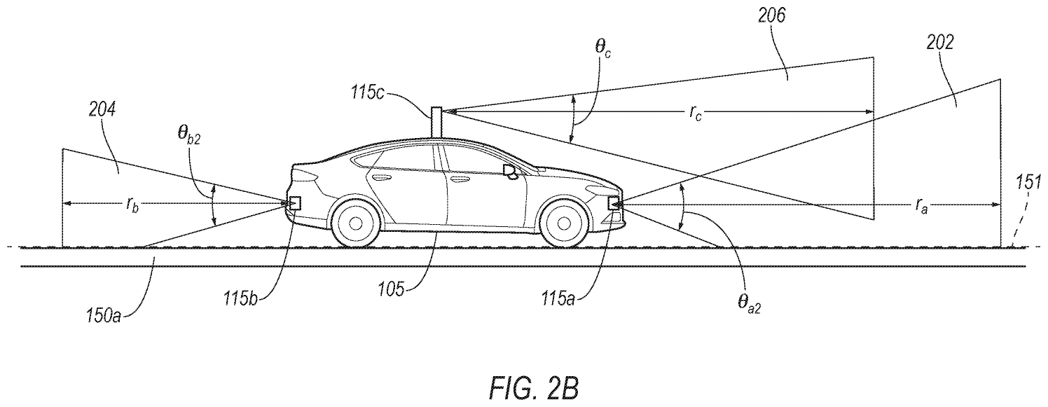

FIGS. 2A and 2B illustrate an example vehicle 105 including example camera sensors 115a, 0115b and an example LiDAR sensor 115c. The vehicle 105 is resting on a surface of a road 150a. A ground plane 151 (FIG. 2B) defines a plane parallel to the surface of the road 150a on which the vehicle 105 is resting. The camera sensor 115a has a field-of-view 202. A field-of-view of a sensor 115, means an open observable area in which objects can be detected by the sensor 115. The field-of-view 202 has a range rₐ extending in front of the vehicle 105. The field-of-view is conically shaped with an apex located at the camera sensor 115a and having an angle-of-view Dai along a plane parallel to the ground plane 151. Similarly, the camera sensor 115b has a field-of-view 204 extending from a rear of the vehicle 105 having a range r_{b} and an angle-of-view θ_{b1} along a plane parallel to the ground plane 151. The LiDAR sensor 115c has a field-of-view 206 that surrounds the vehicle 105 in a plane parallel to the ground plane 151. The field-of-view has a range r_{c}. The field-of-view 206 represents the area over which data is collected during one scan of the LiDAR sensor 115c.

FIG. 2B is a side view of the example vehicle 105 shown in FIG. 2A. As shown in FIG. 2B, the field-of-view 202 of the camera sensor 115a has an angle-of-view θₐ₂ along a plane perpendicular to the ground plane 151, wherein θₐ₂ may be the same or different from θₐ₁. The field-of-view 204 of the camera sensor 115b has an angle-of-view θ_{b2} along a plane perpendicular to the ground plane 151, wherein θ_{b2} may be the same or different from θₐ₁. The field-of-view 206 of the LiDAR sensor 115c has an angle-of-view θ_{c} along a plane perpendicular to the ground plane 151.

FIGS. 2A and 2B illustrate only a few of many sensors 115 that are typically included in the vehicle 105 which can collect data about objects in the environment of the vehicle 105. The vehicle 105 may have one or more radar sensors 115, additional camera sensors 115 and additional LiDAR sensors 115. Still further, the vehicle 105 may have ultrasonic sensors 115, motion sensors 115, infrared sensors 115, etc. that collect data about objects in the environment of the vehicle 105. Some of the sensors 115 may have fields-of-view directed away from sides of the vehicle 105 to detect objects on the sides of the vehicle 105. Other sensors 115 may have fields-of-view directed to collect data from the ground plane. LiDAR sensors 115 may scan 360° as shown for the LiDAR sensor 115c or may scan over a reduced angle. For example, a LiDAR sensor 115 may be directed towards a side of the vehicle 105 and scan over an angle of approximately 180°.

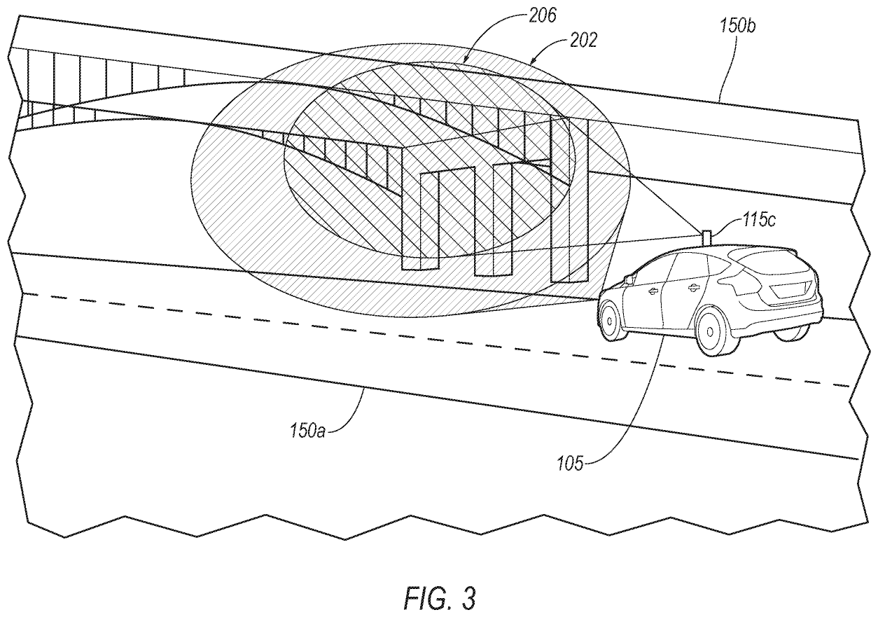

FIG. 3 illustrates an example of the vehicle 105 collecting, i.e., acquiring, data from a bridge 150b. LiDAR sensors 115c have a field-of-view 206 that includes the bridge 150b. Additionally, the vehicle 105 has a camera sensor 115a with a field of view 202 that also includes the bridge 150b. As the vehicle 105 approaches and passes under the bridge 150b, the computer 110 can receive the LiDAR data from the LiDAR sensor 115c and camera data from the camera sensor 115a, both the LiDAR data and camera data including data that describes one or more physical characteristics of the bridge 150b. The computer 110 applies the vehicle data for driving the vehicle 105 and further stores the data in the data store 130.

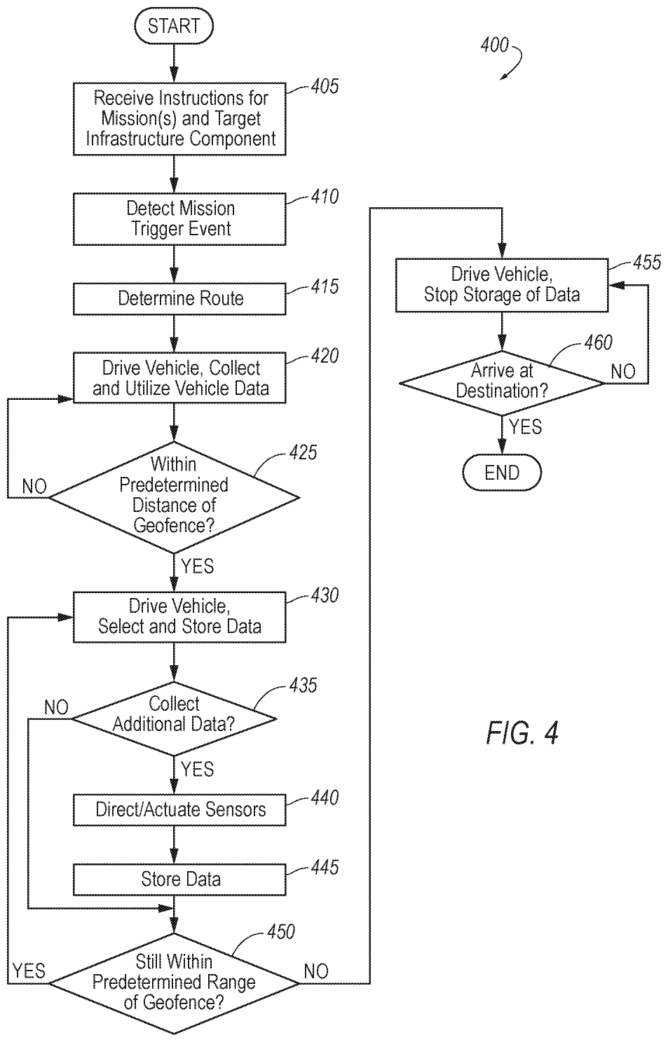

FIG. 4 is a diagram of process 400 for selecting vehicle data that includes or may include data about a target road infrastructure element 150 and storing the selected data in the data store 130. The process 400 begins in a block 405.

In the block 405, the computer 110 in the vehicle 105 receives instructions with parameters defining one or more missions, as described above. The instructions may further include a map of the environment in which the vehicle is operating, data identifying a target road infrastructure element 150, and may further include data defining a geofence 160 around the target road infrastructure element 150. The computer 110 may receive the instructions, for example, from the server 145 via the network 140. The identification of the target road infrastructure element 150 includes a location of the target road infrastructure element 150 represented, for example, by a set of latitude and longitude coordinate pairs. Alternatively or additionally, the location of the target road infrastructure element 150 may be provided as two-dimensional or three-dimensional map data. The identification may include a two-dimensional image and/or three-dimensional model of the target road infrastructure element 150. The geofence 160 is a polygon represented by a set of latitude, longitude coordinate pairs that surrounds the target road infrastructure element 150.

Upon receiving the instructions, the process 400 continues in a block 410.

In the block 410, the computer 110 detects a mission trigger event, i.e., a receipt of data that is specified to initiate a mission. The mission trigger event may be, for example: a time of day equal to a scheduled time to start a mission; an input from a user of the vehicle 105, for example via a human machine interface (HMI) to start the mission; or an instruction from the server 145 to start the mission. Upon detecting the mission trigger event by the computer 110, the process 400 continues in a block 415.

In the block 415, in a case wherein the vehicle is operating in an autonomous mode, the computer 110 determines a route for the vehicle 105. In some cases, the route may be specified by the mission instructions. In other cases, the mission instructions may include one or more destinations for the vehicle 105 and may further include a map of the environment in which the vehicle 105 will be operating. The computer 110 may determine the route based on the destinations and the map data, as is known. The process 400 continues in a block 420.

In the block 420, the computer 110 operates the vehicle 105 along the route. The computer 110 collects vehicle data, including radar data, LiDAR data, camera data and GPS data as described above. Based on the vehicle data, the computer determines a current location of the vehicle 105, determines a planned travel path, and operates the vehicle along the planned travel path. As noted above, the computer 110 may apply localization techniques to determine a localized position of the vehicle 105 with increased resolution based on the vehicle data. The process continues in a block 425.

In the block 425, the computer 110 determines whether the vehicle 105 is within a threshold distance of a geofence 160 surrounding a target road infrastructure element 150. The threshold distance may be distance, within which the field-of-view of one or both of LiDAR sensors 115 or camera sensors 115 can collect data from objects within the geofence 160, and may be, for example, 50 meters. In case the vehicle 150 is within the threshold distance of the geofence 160, the process 400 continues in a block 430. Otherwise, the process 400 continues in the block 420.

In the block 430, the computer 110 selects data from the vehicle data and stores the selected data. The computer 110 may select the data to be stored based on one or more target road infrastructure element parameters. Target road infrastructure element parameters, as used herein, are characteristics that assist in defining or classifying the target road infrastructure element or a target section of the road infrastructure element. Examples of infrastructure element parameters that can be used to select the data to be stored include: a type of the target road infrastructure element 150, the geolocation, a location of an area of interest of the target road infrastructure element 150, the dimensions (height, width, depth), the material composition (cement, steel, wood, etc.), the type of surface covering, possible types of deterioration, age, a current loading (e.g., heavy load on the target road infrastructure element 150 due to heavy traffic or a traffic backup), or a condition of interest of the target road infrastructure element 150 etc. A type of target road infrastructure element 150 in this context means a classification or category of target road infrastructure element having common features. Non-limiting types of target road infrastructure elements include roads, bridges, tunnels, towers, etc. A condition of interest of the target road infrastructure element 150 herein is a type of wear or deterioration that is currently being evaluated. For example, if deterioration of a surface coating (e.g., paint) or corrosion of the target road infrastructure element 150 are of current interest, the computer 110 may select camera data to be stored. If spalling, deformation of elements, displacement of elements, etc. are currently being evaluated, the computer 110 may select both camera and LiDAR data for storage.

Additionally, the computer 110 may select the data to be stored based on vehicle parameters. Vehicle parameters as used herein are data values that at least partly define and/or classify the vehicle a state of operation of the vehicle. Example of vehicle parameters that can be used to select the data include: a location (absolute or relative to the target road infrastructure element 150) of the vehicle 105 and a field-of-view of the sensors 115 of the vehicle at a time of receiving the vehicle data.

Still further, the computer 110 may select the data to be stored based on one or more environmental parameters. Environment parameters as used herein are data values that at least partly define and/or classify an environment and/or a condition of the environment. For example, light conditions and weather conditions are parameters that the computer 110 can use to determine which data to select from the vehicle data.

As non-limiting examples, selecting vehicle data to be stored can include selecting a type of the vehicle data, selecting data based on a sensor 115 that generated the data, and selecting a subset of data generated by a sensor 115 based on a timing of the data collection. A type of vehicle data herein means a specification of a sensor technology (or medium) by which the vehicle data was collected. For example, radar data, LiDAR data and camera data are types of vehicle data.

As an example, the computer 110 can be programmed, as a default condition, to select all LiDAR and camera-based vehicle data when the vehicle 105 is within the threshold distance of the geofence 160 surrounding the target road infrastructure element 150.

As another example, the computer 110 can be programmed to identify the selected data based on a type of target road infrastructure element 150. For example, if the target road infrastructure element 150 is a road 150, the computer 110 may identify selected data to be data collected from sensors 115 with a field-of-view including the road 150. If, for example, the target road infrastructure element 150 is an inside of a tunnel 150, the computer 110 may identify the selected data to be data collected during a time at which the vehicle 105 is inside the tunnel 150.

As another example, the computer 110 can be programmed to select data from the vehicle data based on the field-of-view of sensors 115 collecting the data. For example, cameras 115 on the vehicle 105 may have respective fields-of-view in front of the vehicle 105 or behind of the vehicle 105. As the vehicle 105 is approaching the target road infrastructure element 150, the computer 110 may select camera data from cameras 115 directed in front of the vehicle 105. When the vehicle 105 has passed the target road infrastructure element 150, the computer 110 may select camera data from cameras 115 directed behind the vehicle 105.

Similarly, the computer 110 may select LiDAR data based on a field-of-view of the LiDAR at the time the data is received. For example, the computer 110 may select the LiDAR from those portions of a scan (based on timing of the scan) when the LiDAR data may include data describing one or more physical characteristics of the target road infrastructure element 150.

In cases where only a section of the target road infrastructure element 150 is of interest, the computer 110 may select the data when the field-of-view of sensors 115 includes or likely includes data describing one or more physical characteristics of the section of interest of the target road infrastructure element 150.

In some cases, the computer 110 may select the data to be stored based on the type of deterioration of the target road infrastructure element 150 to be evaluated. For example, in a case that the condition of the paint or the amount of corrosion on the target road infrastructure element 150 is to be evaluated, the computer 110 may select only data from cameras 115.

Further, in some cases, the computer 110 may select data from the vehicle data to be stored based on light conditions in the environment. For example, In a case that it is too dark to collect image data with cameras 115, the computer 110 may select LiDAR data to be stored and omit camera data.

Still further, in some cases, the type of data to be stored may be determined based on instructions received from the server 145. Based on planned usage of the data, the server 145 may send instructions to store certain vehicle data and not store other vehicle data.

The computer 110 may further collect and store metadata together with the selected vehicle data. For example, the computer 110 may store a time stamp with frames of camera data, or scans of LiDAR data, indicating when the respective data was received. Further, the computer 110 may store a location of the vehicle 105, as latitude and longitude coordinate pairs, with the respective data. The location of the vehicle 105 may be based on GPS data, or a position based on localization of the vehicle 105 based on additional vehicle data. Still further, the metadata may include weather data at the time of collecting the respective data, light conditions at the time of collecting the respective data, identification of a sensor 115 that was used to collect the data, and any other measurements or conditions that may be useful in evaluating the data. In the case of LiDAR data, the metadata may be associated with an entire scan, sets of data points, or individual data points.

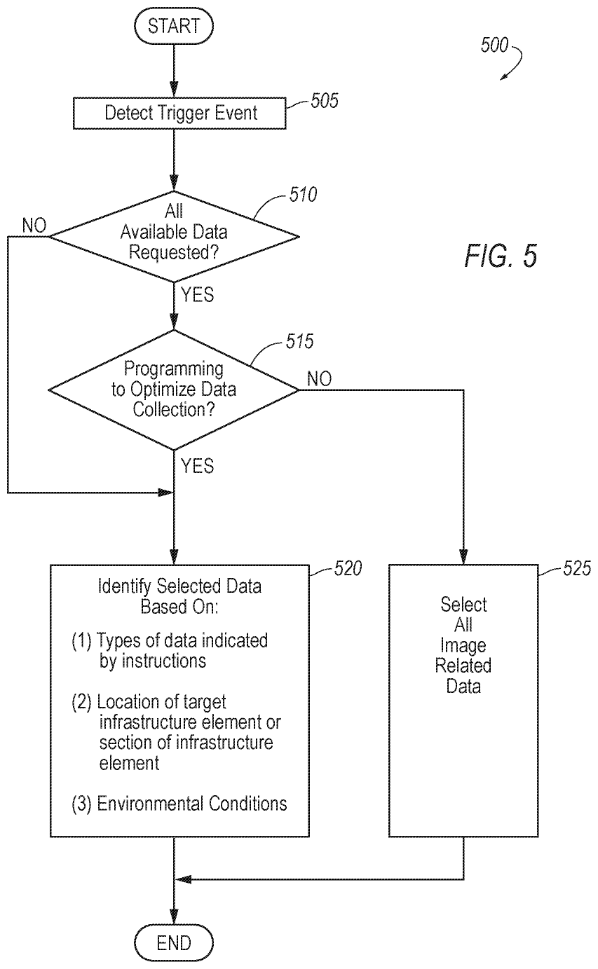

An example process 500 for identifying selected vehicle data for storage, which can be called as a subroutine by the process 400, is described below in reference to FIG. 5. Upon identifying the selected vehicle data for storage, for example, according to the process 500, the process 400 continues in a block 435.

In the block 435, the computer 110 determines whether it should collect additional data from the target road infrastructure element 150, beyond the data available from the vehicle data. For example, the instructions received from the server 145 may identify sections of interest of the target road infrastructure element 150 that do not appear in the fields-of-view of sensors 115 as used for collecting the vehicle data. If the computer 110 determines that it should collect additional data, the process 400 continues in a block 440. Otherwise, the process 400 continues in a block 450.

In the block 440, the computer 110 directs and/or actuates sensors 115 to collect additional data about the target road infrastructure element 150. In an example, the computer 110 may actuate sensors 115 not used for vehicle navigation at a time when the section of interest of the target road infrastructure element 150 is in the field-of-view of the sensor 115. The sensor 115 may be, for example, a camera sensor 115 on a side of the vehicle 105 that is not utilized to collect vehicle data for navigation. When, based on a location of the vehicle 105, the section of interest of the target road infrastructure element is within the field-of-view of the camera sensor 115, the computer 110 may actuate the sensor 115 and collect data about the section of interest of the target road infrastructure element. In another example, the computer 110 may actuate a rear camera sensor 115 on the vehicle 105 that is not used during forward operation of the vehicle 105, to obtain a view of the section of interest of the target road infrastructure element 150 from the rear of the vehicle 105 as the vehicle 105 passes the section of interest.

In other scenarios, if it does not interfere with vehicle navigation, sensors 115 used to collect vehicle data while driving the vehicle 105 may be redirected, for example, by temporarily changing the direction, focal length, or angle-of-view of the field-of-view the sensor 115 to collect data about the section of interest of the target road infrastructure element 150. The process continues in a block 445.

In the block 445, the computer 110 stores the data, together with related metadata, as described above in reference to the block 430. The process 400 continues in a block 450.

In the block 450, which may follow the block 435, the computer 110 determines whether the vehicle 105 is still within range of the geofence 160. If the vehicle 105 is still within range of the geofence 160, the process 400 continues in the block 430. Otherwise, the process 400 continues in a block 455.

In the block 455, the computer 110 continue to operate the vehicle 105 based on the vehicle data 105. The computer 110 discontinues selecting vehicle data for storage as described in reference to the block 430 above. The process 400 continues in a block 460.

In the block 460, the computer 110 determines whether the vehicle 105 has arrived at an end destination for the mission. If the vehicle 105 has arrived at the end destination, the process 400 ends. Otherwise, the process 400 continues in the block 455.

FIG. 5 is a diagram of the example process 500 for identifying selected vehicle data for storage by the computer 110. The process 500 begins in a block 505.

In the block 505, the computer 110 detects a process 500 trigger event, i.e., a receipt of data that is specified to initiate the process 500. The process 500 trigger event may be, for example a digital signal, flag, call, interrupt, etc. sent, set or executed by the computer 110 during execution of the process 400. Upon detecting the process 500 trigger event, the process 500 continues in a block 510.

In the block 510, the computer 110 determines whether received instructions, such as instructions received according to block 405, specify that the computer 110 is to identify selected vehicle data to be all useful image and 3D-model data, i.e., data obtained via a medium (i.e., via a sensor type) predefined as potentially useful to evaluate an infrastructure element 150 that the computer 110 receives during operation of the vehicle 105. The data may be predefined, for example, by the manufacturer and may include LiDAR sensor data, camera sensor data, and other data that may be used to create images and/or 3D models of an infrastructure element 150 or otherwise evaluate a condition of the infrastructure element 150.

For example, identifying all useful image and 3D-model data as the selected vehicle data may be a default condition, when the instructions specify a geofence 160 and/or target infrastructure element 150, but do not further define which data is of interest; in this instance, the received instructions are deemed to specify selecting all useful image and 3D-model data when this default condition is not specified to be altered or overridden. In any case that, based on the instructions, the computer 110 determines that all useful image and 3D-model data is requested, and the process 500 continues in a block 515. Otherwise, the process 500 continues in a block 520.

In the block 515, the computer 110 determines whether the computer 110 includes programming to limit the amount of selected data. For example, in some cases, the computer 110 may be programmed to limit the amount of data collected to conserve vehicle 105 resources such as storage capacity of the data store 130, bandwidth or throughput of the vehicle communications network, data upload bandwidth or throughput, etc. In the case that the computer 110 is programmed to limit an amount of collected data, the process 500 continues in a block 520. Otherwise, the process continues in a block 525.

In the block 520, the computer 110 identifies selected vehicle data based on (1) types of data specified by the received instructions (i.e., of the block 405), (2) a location of the target infrastructure element or target section of the infrastructure element, and/or (3) environmental conditions.

Typically, as a first sub-step of the block 520, the computer 110 determines the types of data to be collected, based on the received instructions. In some cases, the instructions may explicitly specify types of data to be collected. For example, the instructions may request camera data, LiDAR data, or both camera and LiDAR data. In other cases, the instructions may identify conditions of interest of the target infrastructure element 150 and based on the types of conditions of interest, the computer 110 may determine types of data to collect. Conditions of interest, as used herein, are conditions of the target infrastructure element 150 which are currently subject to evaluation, for example, based on a maintenance or inspection schedule for the infrastructure element 150. For example, the computer 110 may maintain a table that indicates types of data to collect based on types of deterioration. For example, Table 1 below shows a portion of an example table mapping types of deterioration to types of data to collect.

TABLE 1

| Conditions of Interest | Types of Data to Be Collected |
|---|---|
| General condition | camera and LiDAR data |
| Surface corrosion | camera data |
| Condition of protective | camera data |
| coating (e.g., paint) | |
| Spalling | camera and LiDAR data |
| Three-dimensional shifting or | LiDAR data |
| deformation of elements | |

Based on a determination of which types of data are to be collected based on the received instructions, the computer 110 may further identify the selected vehicle data based on a location of the target infrastructure element 150 or target section of the infrastructure element 150, and/or (3) environmental conditions. As described above, based on the location of the target infrastructure element 150, and a location of the vehicle 105, the computer 110 may select data for LiDAR sensors 115 and data from camera sensors 115 when the target infrastructure element 150 is likely to appear to the field-of-view of the respective sensor 115. Further, the computer 110 may only collect LiDAR and/or camera sensor data, when environmental conditions support collecting data from the respective sensor.

The computer 110 may maintain tables for determining which type of data to collect under different conditions. In an example, the computer 110 may maintain three tables, one each for collecting both LiDAR and camera data, collecting only LiDAR data, and collecting only camera data.

Table 2 below is an example table for identifying vehicle data to collect based on the location of the target infrastructure element 150 and the environmental conditions when both LiDAR and camera data are indicated.

TABLE 2
LiDAR and Camera Data Indicated

| | Conditions | Conditions | |
|---|---|---|---|
| target | support | support | |
| location | collecting | collecting | |
| specified | camera data | LiDAR data | Action |
| n | n | n | No data collection |
| n | n | y | Collect all available LiDAR data while within |
| | | | threshold distance of geofence |
| n | y | n | Collect all available camera data while within |
| | | | threshold distance of geofence |
| n | y | y | Collect all available LiDAR and camera data |
| | | | while within threshold distance of geofence |
| y | n | n | No data collection |
| y | n | y | Collect LiDAR data when LiDAR sensors are |
| | | | within range of the target location |
| y | y | n | Collect camera data when camera sensors are |
| | | | within range of the target location |
| y | y | y | Collect LiDAR and camera data when the |
| | | | respective LiDAR and camera sensors are within |
| | | | range of the target location |

Table 3 below is an example table for identifying vehicle data to collect based on the location of the target infrastructure element 150 and the environmental conditions when only LiDAR data is indicated.

TABLE 3
Only LiDAR Data Indicated

| | Conditions | |
|---|---|---|
| target | support | |
| location | collecting | |
| specified | LiDAR data | Action |
| n | n | No data collection |
| n | y | Collect all available LiDAR data |
| | | while within threshold distance |
| | | of geofence |
| y | n | No data collection |
| y | y | Collect LiDAR data when LiDAR |
| | | sensors are within range of the |
| | | target location. |

Table 4 below is an example table for identifying vehicle data to collect based on the location of the target infrastructure element 150 and the environmental conditions when only camera data is indicated.

TABLE 4
Only Camera Data Indicated

| | Conditions | |
|---|---|---|
| target | support | |
| location | collecting | |
| specified | camera data | Action |
| n | n | No data collection |
| n | y | Collect all available camera data |
| | | while within threshold distance |
| | | of geofence |
| y | n | No data collection |
| y | y | Collect camera data while camera |
| | | sensors are within range of the |
| | | target location |

The computer 110 determines the type of data to be collected based on the received instructions. Based on the type of data to be collected, the computer 110 selects a table from which to identify selected data. The computer then identifies the selected data based on the selected table, the location of the target infrastructure element 150 and environmental conditions. Upon identifying the selected data, the process 500 ends, and the computer 110 resumes the process 400, starting at the block 435.

In the block 525, which follows the block 515, the computer 110 proceeds to identify all useful image and 3D-model data as the selected vehicle data. The process 500 ends, and the computer 110 resumes the process 400, starting at the block 435.

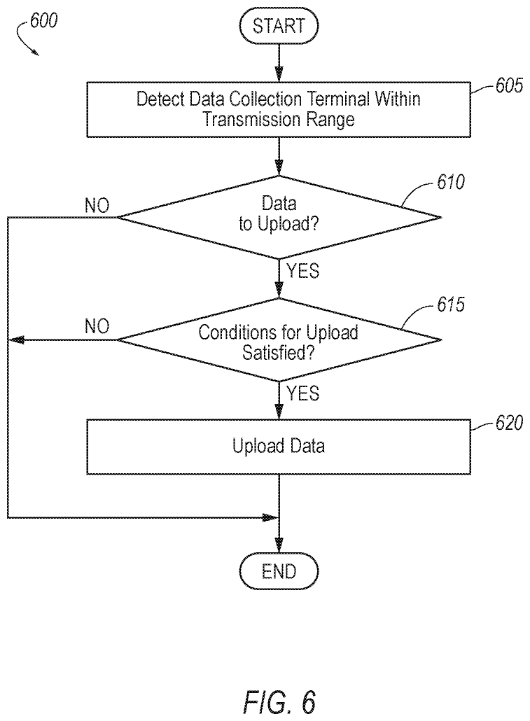

FIG. 6 is a diagram of an example process 600 for upload data from the computer 110 to the server 145. The process 600 begins in a block 605.

In the block 605, the computer 110 in the vehicle 105 detects or determines that the data collection terminal 135, is within range to upload data to the remote server 145. In an example, a communications interface 515 may be communicatively coupled to the server 450. The computer 110, based on the location of the vehicle 105 and the known location of the data collection terminal 135, determines that a distance between the vehicle 105 and the data collection terminal 135 is less than a threshold distance. The threshold distance may be distance that is short enough that a wireless connection can be established between the computer 110 and the data collection terminal 135. In an example, the data collection terminal 135 may be located near or at a service center or a storage area for parking the vehicle 105 when not in use. The data collection terminal 135 may include a wireless communication network such as Dedicated Short-Range Communications (DSRC) or other short-range or long-range wireless communications mechanism. In another example, the data collection terminal 135 may be an Ethernet plug-in station. In this case the threshold distance may be a distance within which the vehicle 105 can plug into the Ethernet plug-in station. As yet another example, the computer 110 may monitor available networks based on received signals and determine that the vehicle 105 is within range of the data collection terminal 135 based on receiving a signal with a signal strength above a threshold strength. The process 600 continues in a block 610.

In the block 610, the computer 110 determines whether it has data to upload. For example, the computer 110 may check to see if a flag has been set (a memory location is set to a predetermined value) indicating that during a mission, the computer 110 collected data about a target road infrastructure element 150 that has not yet been uploaded. In the case that the computer 110 has data that has not yet been uploaded, the process 600 continues in block 615. Otherwise, the process 600 ends.

In the block 615, the computer 110 determines whether conditions are satisfied for uploading the data. For example, the computer 110 can determine, based on a schedule of planned missions for the vehicle 105, that the vehicle 105 has enough time to upload the data before leaving on a next mission. The computer 110 may, for example, determine, based on the quantity of data, how much time is needed to upload the data, and determine that the vehicle 105 will remain parked for at least the amount of time needed to upload the data. The computer 110 may further confirm, via digital communication with the server 450, that the server 450 can upload and store the data. Further, one of the computer 110 or the server 450 may authenticate the other, based on passwords and the like, to establish secure communications between the computer 110 and the server 450. If the conditions are satisfied for uploading data, the process 600 continues in a block 620. Otherwise, the process 600 ends.

In the block 620, the computer 110 transfers the stored data about the target road infrastructure element 150 to the server 450 via the data collection terminal 135. The process 600 ends.

The process 600 is only one example of uploading data from the computer 110 to a server. Other methods are possible for uploading the data about the target road infrastructure element 150. As an example, the computer 110 may upload the data via the network 140 (FIG. 1) to the server 145, or another server communicatively coupled to the network 140.

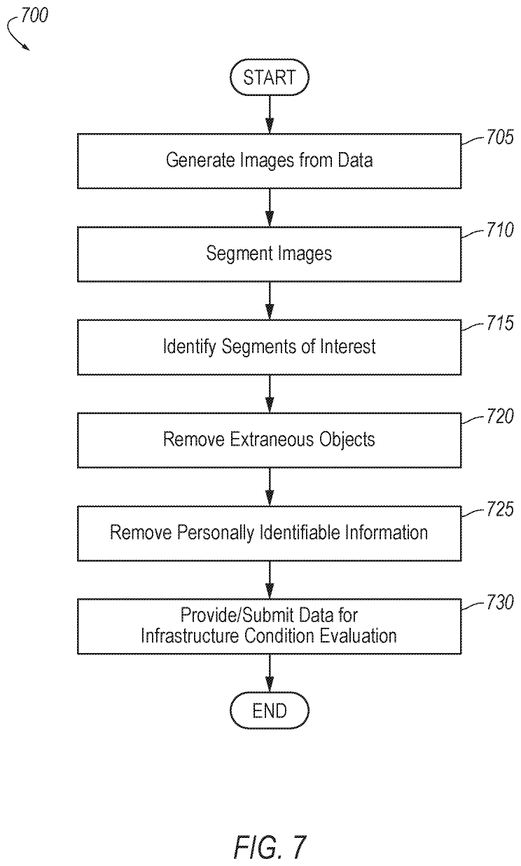

FIG. 7 is a diagram of an example process 700 for conditioning data for use to evaluate the condition of the target road infrastructure element 150. Conditioning the data may include segmenting the data, removing segments that are not of interest, removing objects from the data that are not of interest, and removing personally identifiable information from the data. The process 700 begins in a block 705.

In the block 705, the server 450 generates images and/or 3D-models from the data. The server 450 generates one or more point-cloud 3D models from the LiDAR data, as is known. The server 450 further generates visual images based on the camera data as is known. The server 450 may further generate 3D models that aggregate camera data and LiDAR data. The process 700 continues in a block 710.

In the block 710, the server 450 segments the images and/or 3D models. The computer 110 divides each of the generated 3D models and generated visual images into respective grids of smaller segments. The process continues in a block 715.

In the block 715, the server 450, based on object recognition, e.g., according to conventional techniques, identifies segments of interest. Segments of interest, as used herein, are segments that include data about the target infrastructure element 150. The server 450 applies object recognition to determine which segments include data about the target road infrastructure element 150. The server 450 then removes segments that do not include data about the target road infrastructure element 150. The block 715 continues in a block 720.

In the block 720, the server 450 applies object recognition to identify and remove extraneous objects from the data. The computer 110 may, for example, maintain a list of objects or categories of objects that are not of interest for evaluating a condition of the target infrastructure element 150. The list may include moving objects such as vehicles, pedestrians, and animals that are not of interest. The list may further include stationary objects such as trees, bushes, buildings, etc. that are not of interest in evaluating the condition of the target infrastructure element 150. The server 450 may remove these objects from the data, e.g., using conventional 3D-model and image processing techniques. The process 700 continues in a block 730.

In the block 730, the server 450 may remove personally identifiable information from the data. For example, the server 450 may apply object recognition algorithms such as are known to identify license plates, images or models of faces, or other personally identifiable information in the data. The server 450 may then remove the personally identifiable information from the data, e.g., using conventional image processing techniques. The process 700 continues in a block 730.

In the block 730, the server 450 may provide the data to an application, which may be on another server, for evaluating a condition of the target road infrastructure element 150 based on the data. The process 700 ends.

Although described above as being executed respectively by the computer 110 or the server 145, computing processes such as the processes 400, 500, 600, and 700 can be respectively executed in whole or in part by any of the computer 110, the server 145 or another computing device.

Thus is disclosed a system for selecting and storing vehicle data by a vehicle that includes data about a condition of a target road infrastructure element, uploading the data to a server for conditioning, and conditioning the data for use to evaluate the condition of the target road infrastructure element.

As used herein, the term “based on” means based on in whole or in part.

Computing devices discussed herein, including the computer 110, include processors and memories, the memories generally each including instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Python, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in the computer 110 is generally a collection of data stored on a computer readable medium, such as a storage medium, a random-access memory, etc.

A computer readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random-access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 500, one or more of the steps could be omitted, or the steps could be executed in a different order than shown in FIG. 5. In other words, the descriptions of systems and/or processes herein are provided for the purpose of illustrating certain embodiments and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

The adjectives “first,” “second,” and “third” are used throughout this document as identifiers and are not intended to signify importance or order.

What is claimed is:

1. A system comprising:
a computer including a processor and a memory, the memory including instructions executable by the processor, including instructions to:
collect vehicle sensor data from sensors on a vehicle;
based on a determination that the vehicle is within a threshold distance of a road infrastructure geofence indicating a presence of a target road infrastructure element, identify selected data from the vehicle sensor data; and
transmit the selected data to a remote server.

2. The system of claim 1, wherein:
identifying the selected data includes identifying one or more types of selected data.

3. The system of claim 2, wherein the one or more types of selected data are selected from a set including camera data and LiDAR data.

4. The system of claim 2, wherein identifying the one or more types of selected data is based on a received mission instruction.

5. The system of claim 4, wherein the received mission instruction specifies the one or more types of data to be selected and the instructions include to:
identify the selected data based on the specification of the one or more types of data in the mission instruction.

6. The system of claim 4, wherein the received mission instruction specifies a condition or a type of deterioration of the target road infrastructure element to be evaluated, and the instructions include to:
determine the one or more types of data based the specified condition or type of deterioration to be evaluated.

7. The system of claim 1, wherein:
identifying the selected data is based on one or more road infrastructure element parameters.

8. The system of claim 7, wherein the one or more road infrastructure element parameters include at least one of:
a type of the target road infrastructure element;
a location of the target road infrastructure element;
a physical characteristic of the target road infrastructure element; or
a geolocation of a target section of the road infrastructure element.

9. The system of claim 1, wherein identifying the selected data includes at least one of:
identifying a sensor from which the selected data is generated; or
identifying a timing when the selected data was generated.

10. The system of claim 1, wherein identifying the selected data is based on one or more vehicle parameters.

11. The system of claim 10, wherein the one or more vehicle parameters includes at least one of:
a geolocation of the vehicle; or
a field-of-view of a sensor on the vehicle.

12. The system of claim 1, wherein the instructions further include to:
store the selected data on a memory store on the vehicle; and
transmit the selected data to the remote server when the vehicle is within range of a data collection terminal.

13. The system of claim 1, wherein the instructions further include to:
store the selected data on a memory store on the vehicle prior to transmitting the selected data; and
store a geolocation of the vehicle at a time the vehicle sensor data was selected together with the selected data.

14. The system of claim 13, wherein the geolocation of the vehicle at the time the vehicle sensor data was collected is determined based on at least one of data from a LiDAR sensor included on the vehicle or data from a camera sensor included on the vehicle.

15. The system of claim 1, wherein the instructions further include to:
identify the selected data based on a field of view of a sensor at a time of collecting the vehicle sensor data.

16. The system of claim 15, wherein the instructions further include to:
determine a localized position of the vehicle based on at least one of LiDAR data or camera data; and
determine the field of view of the sensor based on the localized position of the vehicle.

17. The system of claim 1, wherein the instructions include instructions to:
transmit weather data together with the selected data, the weather data indicating weather conditions at a time of collecting the vehicle data.

18. The system of claim 1, further comprising the remote server, the remote server including a second processor and a second memory, the second memory including second instructions executable by the processor, including second instructions to:
receive the selected data transmitted by the processor;
extract second data about a target road infrastructure element from the selected data; and
transmit the second data to a second server.

19. The system of claim 18, wherein extracting the second data includes second instructions to:
remove personally identifying information from the second data prior to transmitting the second data to the second server.

20. The system of claim 18, wherein extracting the second data includes second instructions to:
generate an image and/or 3D model from the selected data;
divide the generated image and/or 3D model into segments;
determine which segments include data about the target road infrastructure element; and
include in the second data, the segments including the data about the target road infrastructure element.
